(19) United States
(12) Patent Application Publication
(10) Pub. No.: US 2025/0360738 A1
(43) Pub. Date: Nov. 27, 2025

(54) PRINTER

(71) Applicant: Toshiba Tec Kabushiki Kaisha, Tokyo (JP)

(72) Inventor: Keito HIRAKATA, Numazu Shizuoka (JP)

(21) Appl. No.: 19/051,123

(22) Filed: Feb. 11, 2025

(30) Foreign Application Priority Data
May 21, 2024 (JP) 2024-082569

(51) Int. Cl. B41J 35/38; B41J 2/325; B41J 3/407; B41J 11/70; B41J 15/04; B41J 33/26; B41J 35/04

(52) U.S. Cl. CPC B41J 35/38; B41J 2/325; B41J 3/4075; B41J 11/70; B41J 15/04; B41J 33/26; B41J 35/04

(57) ABSTRACT

A printer includes a first holder for an ink ribbon, a first pair of rollers configured to convey the ink ribbon along a conveyance path, a print head configured to press the ink ribbon against a print medium to print an image on the print medium, and a second pair of rollers disposed on a downstream side of the first pair of rollers in the conveyance path and capable of crosscutting the ink ribbon.

### CROSS-REFERENCE TO RELATED APPLICATION(S)

This application is based upon and claims the benefit of priority from Japanese Patent Application No. 2024-082569, filed May 21, 2024, the entire contents of which are incorporated herein by reference.

### FIELD

Embodiments described herein relate generally to a printer.

### BACKGROUND

A printer that performs transfer-type printing is known. In such transfer printing, an ink ribbon to be conveyed and a medium such as a sheet conveyed in synchronization with the conveyance of the ink ribbon is heated and pressed between a thermal head and a platen roller, and then the ink ribbon and the medium are separated from each other.

On the used ink ribbon, reverse images of the images that have been printed on the medium remaining. Thus, it is easy to restore the original images from the used ink ribbon. From the viewpoint of preventing information leakage, it is desirable that the used ink ribbon be disposed of in a state in which the reverse images cannot be read.

A technique can be used in which a used ink ribbon is shredded along the conveyance direction by a shredding roller having a cutting unit such as a cutter in a printer.

However, even if the used ink ribbon is shredded along the conveyance direction, there is a possibility that the original image can be easily restored by collecting and rearranging the shredded portions of the ink ribbon. In other words, it would be difficult to establish that the information that has been reversely printed on the used ink ribbon cannot be restored.

### SUMMARY OF THE INVENTION

Embodiments of the present disclosure provide a printer and a method that make it more difficult to restore images printed and left on an ink ribbon.

In one embodiment, a printer comprises: a first holder for an ink ribbon; a first pair of rollers configured to convey the ink ribbon along a conveyance path; a print head configured to press the ink ribbon against a print medium to print an image on the print medium; and a second pair of rollers disposed on a downstream side of the first pair of rollers in the conveyance path and capable of crosscutting the ink ribbon.

### BRIEF DESCRIPTION OF THE DRAWINGS

FIG. 1 is a perspective view illustrating an external appearance of a printer according to an embodiment.

FIG. 2 is a perspective view illustrating an internal structure of the printer.

FIG. 3 is a schematic diagram illustrating an internal structure of the printer.

FIG. 4 is a schematic diagram illustrating an internal structure of the printer.

FIG. 5 is a diagram for explaining a feedback operation of a conventional printer.

FIG. 6 is a diagram for explaining a feedback operation of the conventional printer.

### DETAILED DESCRIPTION

Hereinafter, embodiments will be described in detail with reference to the drawings. The present invention is not limited to the embodiments described below.

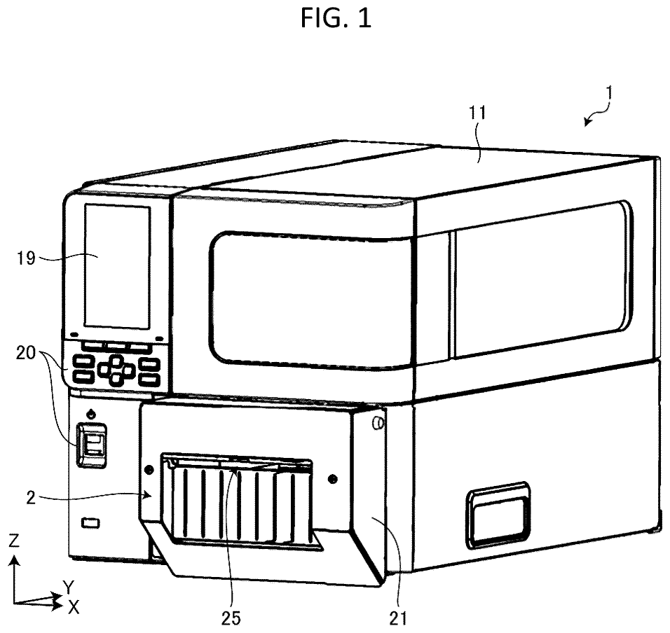

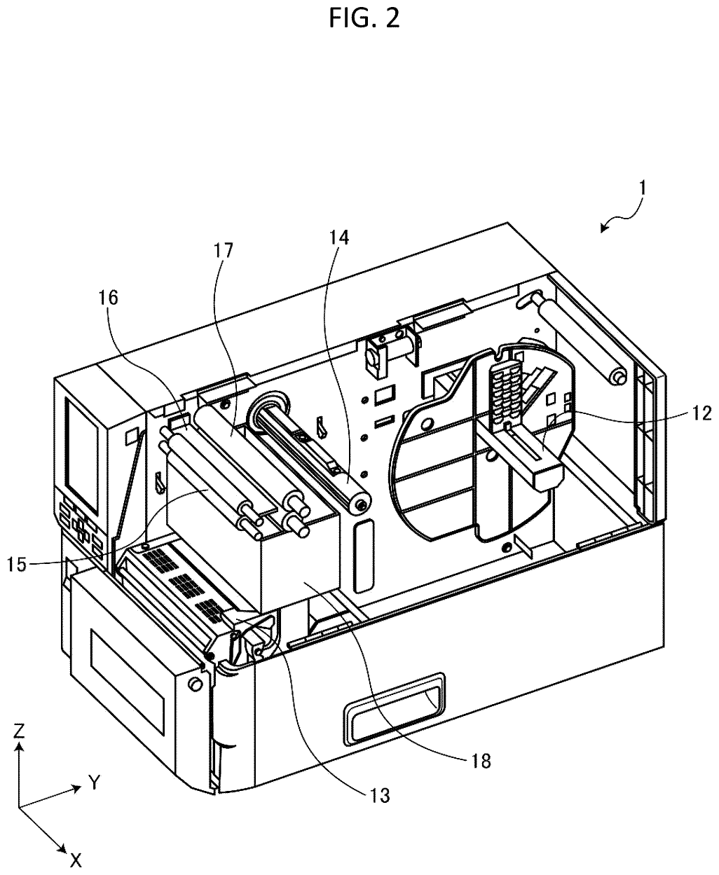

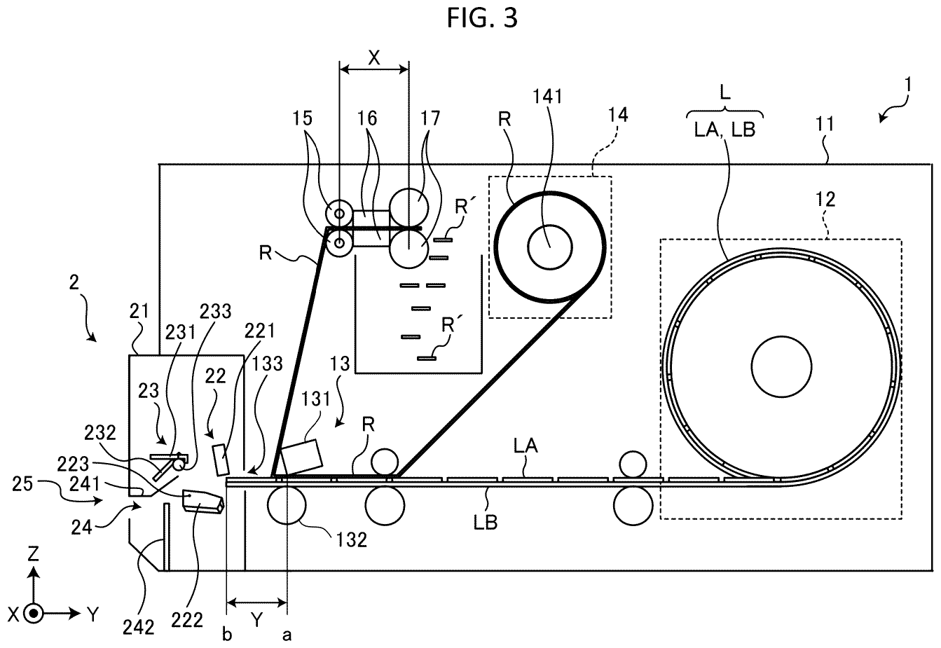

FIG. 1 is a perspective view illustrating an external appearance of a printer 1 according to an embodiment. FIG. 2 is a perspective view illustrating an internal structure of the printer 1. FIG. 2 shows an example of a state of the printer 1 in which a part of the cover of the printer 1 is removed. FIG. 3 is a schematic diagram illustrating an internal structure of the printer 1.

In the following, the configuration of the printer 1 will be described using three axial directions of the X-axis, the Y-axis, and the Z-axis that are orthogonal to each other. The X-axis is an axis passing through the printer 1 from the left side to the right side of the printer 1 when viewed from the front. The Y-axis is an axis that passes through the printer 1 in the front-rear direction and is directed from the front side to the rear side of the printer 1. The Z-axis is an axis that passes through the printer 1 vertically and is directed upward from the lower side of the printer 1. Hereinafter, the Y-axis negative direction side is also referred to as the front side of the printer 1. The Y-axis positive direction side is also referred to as the back side of the printer 1.

The printer 1 is an example of a printer device. The printer 1 is connected to, for example, an information processing apparatus such as a PC so as to be able to communicate with each other by wire or wirelessly. The printer 1 performs printing on a label sheet L. Note that the printer 1 may perform printing on another medium formed of a material such as paper or polyester.

As illustrated in FIGS. 1 to 3, the printer 1 includes a cutter 2, a housing 11, a medium holder 12, a printing unit 13, an ink ribbon holder 14, a pair of ink ribbon conveying rollers 15, an ink ribbon conveying guide 16, a pair of shredding rollers 17, a dust box 18, a display unit 19, and an operation unit 20.

The housing 11 has a substantially box shape and includes the medium holder 12 and the printing unit 13. Further, the printer 1 includes a drive mechanism that drives each unit of the printer 1 inside the housing 11 (not shown). In addition, the housing 11 includes a control unit such as a processor that controls the operation of the printer 1 (not shown).

The medium holder 12 holds the label sheet L wound in a roll shape so as to be able to be fed out. The label sheet L may be formed to include labels of a predetermined dimension on a strip-shaped base sheet, or may be a strip-shaped label without a base sheet. In the example of FIG. 3, the label sheet Lis formed by the labels LA of a predetermined dimension arranged on the base sheet LB side by side.

The printing unit 13 includes a print head 131 and a platen 132. The label sheet L fed out from the medium holder 12 is inserted between the print head 131 and the platen 132, and is conveyed toward a first discharge port 133.

The print head 131 is a thermal head, and performs printing on the label sheet L fed out from the medium holder 12. The print head 131 is a thermal transfer type print head that performs printing on the label sheet L using the ink ribbon R inserted between the print head 131 and the platen 132.

Further, the print head 131 may be a flat edge type thermal head that contacts the label sheet L at a flat portion, or may be a near edge type thermal head that contacts the label sheet L at a corner portion. The label sheet L printed by the print head 131 is conveyed to the cutter 2 through the first discharge port 133.

The ink ribbon holder 14 holds the ink ribbon R wound in a roll shape so as to be able to be fed out. The ink ribbon holder 14 includes a shaft 141. An unused portion of the ink ribbon R is wound and held on the shaft 141. The ink ribbon holder 14 performs the feeding operation and the winding operation of the ink ribbon R by the rotation operation of the shaft 141. That is, the ink ribbon holder 14 functions as an ink ribbon feeding mechanism.

The pair of ink ribbon conveying rollers 15 conveys the used portion of the ink ribbon R for printing on the label sheet L by the print head 131. For example, the pair of ink ribbon conveying rollers 15 sandwiches the used ink ribbon R and rotates clockwise in the drawing to convey the ink ribbon R in the feeding direction in which the ink ribbon R held by the ink ribbon holder 14 is conveyed.

The ink ribbon conveying guide 16 guides conveyance of the ink ribbon R. The ink ribbon conveying guide 16 is provided on the downstream side in the feeding direction of the ink ribbon R and on the upstream side of a pair of shredding rollers 17 described later.

The ink ribbon conveying guide 16 is a pair of plates. One of the plates is provided substantially parallel to the other in the height direction (i.e., the vertical direction) of the printer 1. A gap of a length through which the conveyed ink ribbon R can pass exists between one side and the other side of the ink ribbon conveying guide 16 in the height direction of the printer 1. The ink ribbon conveying guide 16 guides the ink ribbon R by passing the ink ribbon R through the gap.

By guiding the ink ribbon R with the ink ribbon conveying guide 16, the ink ribbon R can be conveyed between one shredding roller and the other shredding roller of the pair of shredding rollers 17 in the height direction of the printer 1.

The pair of shredding rollers 17 illegibly cuts the ink ribbon R from the content reversely printed on the ink ribbon R. The pair of shredding rollers 17 is provided on the downstream side of the pair of ink ribbon conveying rollers 15 in the feeding direction of the ink ribbon R. Further, the pair of shredding rollers 17 has a plurality of cutting blades for cutting the ink ribbon R on the surface thereof.

The pair of shredding rollers 17 rotates clockwise in the drawing to cut and shred the ink ribbon R conveyed by the pair of ink ribbon conveying rollers 15 using the cutting blade on the surface. At this time, the pair of shredding rollers 17 performs cutting or shredding not only in the feeding direction but in the width direction of the printer 1 orthogonal to the feeding direction. For such cutting, for example, a known cutting method such as cross-cutting or micro-cross-cutting can be used as appropriate.

As described above, by performing the cutting both in the feeding direction and in the width direction, the degree of difficulty in restoring the state before the cutting is significantly increased than in the case where the cutting is performed only in the feeding direction. That is, the printer 1 can further reduce the risk of information leakage caused by restoring the contents reversely printed on the ink ribbon R.

The dust box 18 is a receptacle, such as a basket, a tray, or a bin, for collecting an ink ribbon R′ which is the cut ink ribbon R. The dust box 18 is provided below the pair of shredding rollers 17 in the height direction of the printer 1. The ink ribbon R′ cut by the pair of shredding rollers 17 falls in accordance with gravitational force and moves into the dust box 18. Thus, the dust box 18 can collect the ink ribbon R′.

Here, in a conventional printer that performs transfer-type printing, a used ink ribbon is generally wound around a paper core or the like and collected. Therefore, even if the ink ribbon is made of a recyclable material, it may be difficult to collect it as a recyclable material due to the presence of a paper core or the like, which can be made of a different material.

On the other hand, in the printer 1, the ink ribbon R′ is obtained by cutting the ink ribbon R, and does not include a material such as a paper core. Therefore, the dust box 18 can store the ink ribbon R′ in a recyclable manner.

The display unit 19 includes a display device such as a liquid crystal display (LCD). The display unit 19 displays various kinds of information on a screen indicating the state of the printer 1 and the state of the cutter 2 under the control of a control unit (not shown) included in the printer 1.

The operation unit 20 includes various keys and/or buttons related to the operation of the printer 1. For example, the operation unit 20 includes a power button, a paper feed button, and the like. The power button is an operation button for switching between operation and non-operation of the printer 1. The paper feed button is an operation button for instructing to drive a motor or the like to feed the label sheet L in the conveyance direction.

The cutter 2 includes one or more blades 22 to cut the label sheet L conveyed through the first discharge port 133 to a predetermined length. For example, the cutter 2 cuts the label sheet L at the position between the label LA printed by the printing unit 13 of the label sheet L and the label LA to be printed next in the widthwise direction (i.e., the X-axis direction).

The cutter 2 is provided at a portion of the printer 1 facing the first discharge port 133, and receives the input of the label sheet L printed by the printing unit 13 via the first discharge port 133. The cutter 2 may be provided integrally with the printer 1 or may be detachably attached to the printer 1.

Here, it is assumed that an area outside the first discharge port 133 is outside the printer 1, whether the cutter 2 is provided integrally with the printer 1 or detachably attached to the printer 1.

The cutter 2 includes the blades 22, a conveyance unit 23, and a guide unit 24 inside the housing 21. The cutter 2 may include a driving mechanism that drives each part of the cutter 2 in addition to a driving mechanism provided in the housing 11 inside the housing 21 (not shown).

The blades 22 cut the label sheet L. The conveyance unit 23 conveys the label sheet L cut by the blades 22 and discharges the label sheet L from a second discharge port 25 provided in the housing 21. The guide unit 24 guides the conveyance of the label sheet L cut by the blades 22. Here, a path and a direction from the first discharge port 133 toward the second discharge port 25 are a conveyance path and a conveyance direction of the label sheet L in the cutter 2.

The blades 22 includes a mechanism for cutting the label sheet L conveyed from the printing unit 13. Specifically, the blades 22 includes a fixed blade 221 and a movable blade 222.

The fixed blade 221 is installed at a rear stage of the first discharge port 133 and above the conveyance path and faces the conveyance path at a lower end. On the other hand, the movable blade 222 is provided below the conveyance path. The movable blade 222 is a substantially plate-shaped member extending in the width direction (i.e., the left-right direction) of the cutter 2. The movable blade 222 has a support shaft 223 parallel to the width direction of the cutter 2 at a position eccentric to the downstream side in the conveyance direction (i.e., the front side of the cutter 2), and is rotatable about an axis of the support shaft 223.

The upper surface of the movable blade 222 serves as a placing surface for placing the cut label sheet L. The upper surface of the movable blade 222 forms a part of the conveyance path in the process of cutting the label sheet L. The upper surface of the movable blade 222 may be a flat surface, or may have a chevron shape or the like in consideration of the conveyance of the label sheet L. Further, the upper surface of the movable blade 222 is preferably a smooth surface in order to realize smooth conveyance of the label sheet L.

Further, an end surface (for example, an upper end portion) of the movable blade 222 on the upstream side in the conveying direction (i.e., the rear side of the cutter 2) is provided with a blade (hereinafter, also referred to as a blade surface) toward the conveyance path. The movable blade 222, with rotation around the support shaft 223, the blade surface of the movable blade 222 from below the conveyance path above, by moving from above to below, cutting across the label sheet L between the fixed blade 221. That is, the movable blade 222, the blade surface of the movable blade 222 by the rotation around the support shaft 223 so as to pass through the position where meshes with the fixed blade 221, the arrangement position, size, shape, and the like are designed.

The conveyance unit 23 is provided on the downstream side of the blades 22 in the conveyance direction and above the conveyance path. The conveyance unit 23 performs an operation for conveying the label sheet L cut by the blades 22 to the second discharge port 25. Specifically, the conveyance unit 23 includes a first paddle unit 231, a second paddle unit 232, and a paddle rotation shaft 233.

The paddle rotation shaft 233 is provided along the width direction of the cutter 2. The paddle rotation shaft 233 rotates in a clockwise direction in the drawing corresponding to the conveyance direction of the label sheet L. The first paddle unit 231 and the second paddle unit 232 are attached to the paddle rotation shaft 233, and thus rotate in a clockwise direction in the drawing as the paddle rotation shaft 233 rotates.

Here, the first paddle unit 231 and the second paddle unit 232 have different attachment angles with respect to the paddle rotation shaft 233. Specifically, as the paddle rotation shaft 233 rotates, the first paddle unit 231 enters the conveyance path first, and then the second paddle unit 232 enters the conveyance path, so that the attachment angle to the paddle rotation shaft 233 is different.

The attachment angle difference between the first paddle unit 231 and the second paddle unit 232 is not particularly limited, but is preferably adjusted according to the type of the label sheet L or the like.

The guide unit 24 guides the label sheet L cut by the blades 22. Specifically, the guide unit 24 includes an upper guide unit 241 and a lower guide unit 242.

The upper guide unit 241 is provided above the conveyance path and behind the blades 22. More specifically, the upper guide unit 241 is provided between the upper surface of the movable blade 222 and the paddle rotation shaft 233. Further, the upper guide unit 241 is provided so as to be movable in the vertical direction in conjunction with the movable blade 222. The upper guide unit 241 moves in the vertical direction in conjunction with the movable blade 222 to guide the label sheet L that has passed between the fixed blade 221 and the movable blade 222 in the conveyance direction of the conveyance path.

On the other hand, the lower guide unit 242 is provided below the conveyance path and below the conveyance unit 23. Specifically, the lower guide unit 242 is provided substantially below the paddle rotation shaft 233 in the vertical direction. The lower guide unit 242 guides the conveyance of the label sheet L to the second discharge port 25 by supporting the label sheet L scraped out from the upper surface of the movable blade 222 by the conveyance unit 23 from below in the conveyance path.

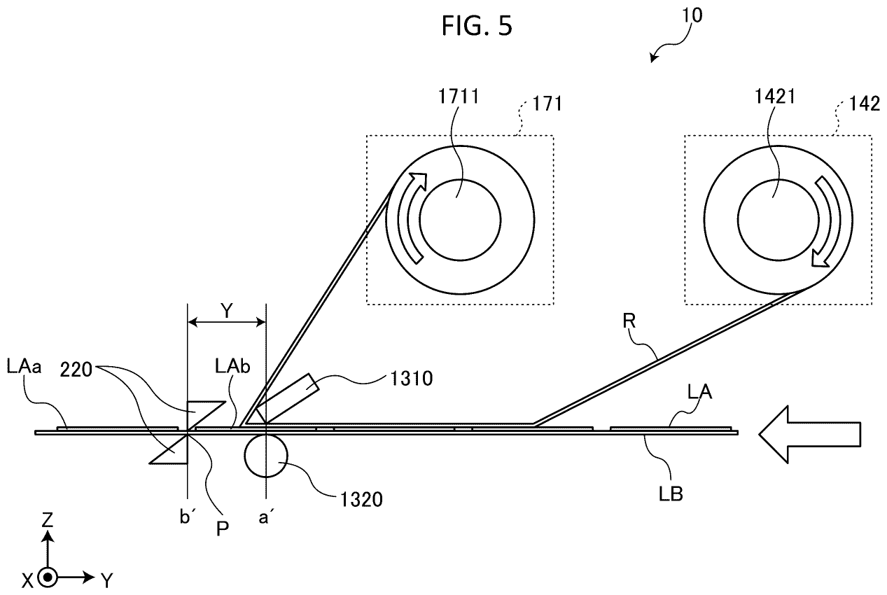

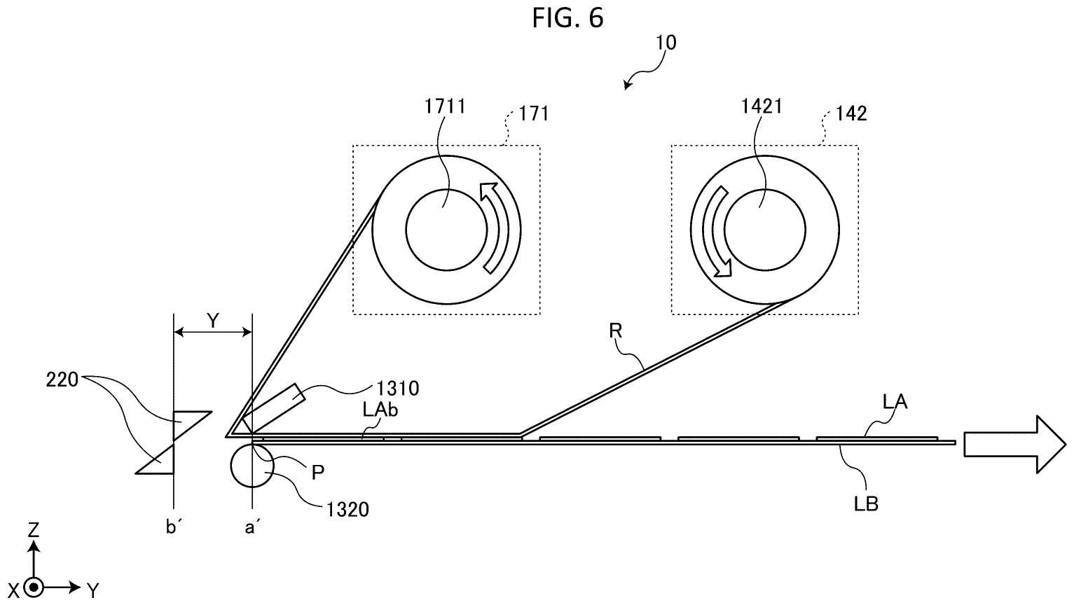

Here, a conventional printer having a cutter generally performs a back feed operation. For example, the back feed operation is an operation in which the label sheet is moved to a position where the printed label is cut, and then the label sheet is pulled back to a position where the next label can be printed. First, with reference to FIG. 5 and FIG. 6, a back feed operation will be described using a conventional printer 10 different from the printer 1 as described above.

FIG. 5 and FIG. 6 are diagrams for explaining a feedback operation of the printer 10. As illustrated in FIGS. 5 and 6, the printer 10 includes a cutter 220, a print head 1310, a platen 1320, an ink ribbon holder 142, and an ink ribbon winding unit 171.

Since the cutter 220, the print head 1310, the platen 1320, and the ink ribbon holder 142 are the same as the cutter 2, the print head 131, the platen 132, and the ink ribbon holder 14 of the printer 1 described above, the description thereof will be omitted. The ink ribbon winding unit 171 performs the feeding operation and the winding operation of the used ink ribbon R by the rotation operation of the shaft unit 1711.

In FIGS. 5 and 6, a printing position at which printing is performed on the label LA by the print head 1310 is a′, a cutting position at which the label sheet L is cut by the cutter 220 (i.e., a discharge position of the label sheet L) is b′, a distance from the printing position a′ to the cutting position b′ (i.e., a conveyance distance of the label sheet L) is Y, a printed label is LA, a label to be printed is LAb, and a middle point between the lower end of LAa and LAb in the conveyance direction is P.

When printing is completed, the printer 10 conveys the label sheet L such that the print head 1310 and the platen 1320 are located at the point P in the conveyance direction.

First, as shown in FIG. 5, in order to cut the label LAa, the printer 10 rotates a shaft unit 1421 of the ink ribbon holder 142 and the shaft unit 1711 of the ink ribbon winding unit 171, and moves the point P of the label sheet L by the distance Y (hereinafter, also referred to as overlap) to the cutting position b′.

After the label LAa is cut by the cutter 220, as shown in FIG. 6, the printer 10 rotates the shaft unit 1421 of the ink ribbon holder 142 and the shaft unit 1711 of the ink ribbon winding unit 171, and pulls back the label sheet L by the overlapping distance Y. As a result, the point P of the label sheet L moves to the position where the print head 1310 and the platen 1320 are present in the conveyance direction. This is the back feed operation in the printer 10.

As shown in FIG. 5, when the label LAa is cut, the point P of the label sheet L is located downstream of the position where the print head 1310 and the platen 1320 are located in the conveyance direction. In other words, the leading end of the label LAb is located downstream of the position where the print head 1310 and the platen 1320 are located. Therefore, in FIG. 5, the print head 1310 and the platen 1320 cannot be printed on the area of the label LAb located downstream of the position.

The printer 10 performs a back feed operation to bring the label sheet L back to the position shown in FIG. 6 so that the upper end of the label LAb in the conveyance direction is located upstream of the position where the print head 1310 and the platen 1320 are located. This allows the printers 10 to print on the entire surface of the label LAb.

Incidentally, since the reversely printed images are left on the used ink ribbon R, a technique of replacing the ink ribbon winding unit 171 with a shredding roller capable of cutting the ink ribbon R along the conveyance direction for the purpose of preventing information leakage has been proposed. However, when this technique is applied to the printer 10, the back feed operation described above may be difficult.

This is because, in order to perform the back feed operation, the ink ribbon winding unit 171 is required to uniformly apply tension to the entire width of the ink ribbon R in the conveying direction of the ink ribbon R. Specifically, in the above-described technique, the cut ink ribbon R is rewound during the back feed operation, and thus it is impossible to give uniform tension to the ink ribbon R.

In addition, there is a possibility that the ink ribbon R after cutting by the above-described technique is entangled with the shredding roller. In this case, there is a possibility that the ink ribbon R may not be wound well during the back feed operation, and the shredding rollers may fail.

On the other hand, the printer 1 realizes both cutting of the ink ribbon R by taking a distance between the pair of ink ribbon conveying rollers 15 and the pair of shredding rollers 17, and performing continuous cutting operation of the label sheet L by performing a back feed operation. Referring back to FIG. 3, the reason why both can be realized will be described.

In FIG. 3, a printing position for printing on the label LA is denoted by a, a cutting position for cutting the label sheet L (i.e., a position of the first discharge port 133) is denoted by b, a distance from the printing position a to the cutting position b (i.e., a conveyance distance of the label sheet L) is denoted by Y, and a distance between the pair of ink ribbon conveying rollers 15 and the pair of shredding rollers 17 (i.e., a conveyance distance of the ink ribbon R) is denoted by X.

For example, the pair of ink ribbon conveying rollers 15 and the pair of shredding rollers 17 are provided so that the relationship of X>=Y is satisfied. This is because the back feed distance of the overlapped portion is Y, and the pair of ink ribbon conveying rollers 15 can sandwich the ink ribbon R even when the ink ribbon R of the distance Y is pulled back.

In other words, when X<Y is satisfied, the leading end of the ink ribbon R in the conveyance direction is positioned upstream of the pair of ink ribbon conveying rollers 15 when the back feed operation is performed. That is, when X<Y is satisfied, the pair of ink ribbon conveying rollers 15 cannot sandwich the ink ribbon R (i.e., the ink ribbon R deviates from the pair of ink ribbon conveying rollers 15), and the ink ribbon R cannot be conveyed.

Therefore, by providing the pair of ink ribbon conveying rollers 15 and the pair of shredding rollers 17 so that the relationship of X>=Y is satisfied, it is possible to achieve both the cutting of the ink ribbon R and the continuous cutting operation of the label sheet L by performing the back feed operation.

In the back feed operation, the ink ribbon R deviates from the pair of shredding rollers 17. However, in the printer 1 described above, the ink ribbon conveying guide 16 is provided between the pair of ink ribbon conveying rollers 15 and the pair of shredding rollers 17.

Therefore, when printing is resumed after the back feed operation, the printer 1 can convey the ink ribbon R between one shredding roller and the other shredding roller of the pair of shredding rollers 17 in the height direction of the printer 1. That is, in the printer 1, it is possible to quickly shift to the normal rotation operation after the back feed operation.

As described above, the printer 1 includes the ink ribbon holder 14 that supports the unused ink ribbon R wound around the shaft 141 and performs the feeding and winding of the ink ribbon R by the rotation operation of the shaft 141, the print head 131 that heats the unused ink ribbon R that has been fed and prints on the label sheet L, the pair of ink ribbon conveying rollers 15 that sandwiches the used ink ribbon R used for printing on the label sheet L and conveys the ink ribbon R in the feeding direction of the ink ribbon R, and the pair of shredding rollers 17 that is provided on the downstream side of the pair of ink ribbon conveying rollers 15 in the feeding direction and cuts or shreds the conveyed ink ribbon R in the width direction orthogonal to the feeding direction and the feeding direction of the ink ribbon R.

In the printer 1, by cutting the ink ribbon R in the width direction orthogonal to the feeding direction, it is possible to make the content reversely printed on the ink ribbon R unreadable. Further, since the printer 1 includes the pair of ink ribbon conveying rollers 15, even if the ink ribbon R is cut in the width direction, the conveyance and winding operation of the ink ribbon R can be performed by performing the rotation operation of the shaft 141 in a state where the ink ribbon R is sandwiched between the pair of ink ribbon conveying rollers 15. That is, according to the printer 1, it is possible to make the information reversely printed on the ink ribbon unreadable efficiently.

Further, the printer 1 further includes the first discharge port 133 for discharging the label sheet L. Further, in the printer 1, the pair of ink ribbon conveying rollers 15 convey the ink ribbon R in a direction opposite to the feeding direction. In the printer 1, the distance between the pair of ink ribbon conveying rollers 15 and the pair of shredding rollers 17 is equal to or greater than the distance between the print head 131 and the first discharge port 133.

Since the distance between the pair of ink ribbon conveying rollers 15 and the pair of shredding rollers 17 is equal to or greater than the distance between the print head 131 and the first discharge port 133, it is possible to prevent the ink ribbon R from deviating from the pair of ink ribbon conveying rollers 15 even if the back feed operation for conveying the ink ribbon R in the opposite direction in the feeding direction is performed. That is, according to the printer 1, it is possible to realize the cutting of the ink ribbon R and the continuous back feed operation.

Further, the printer 1 further includes the cutter 2 that includes the fixed blade 221 provided above the conveyance path for conveying the printed label sheet L and the movable blade 222 provided below the conveyance path.

The printer 1 can perform printing on the entire surface of the subsequent label LA even if the printed label LA is cut by performing the back feed operation after the cut of the printed label LA.

It is to be noted that the above-described embodiments can be appropriately modified and implemented by changing a part of the configuration or the function of the printer 1. Therefore, in the following, some modifications according to the above-described embodiments will be described as other embodiments. Note that, in the following, differences from the above-described embodiments will be mainly described, and detailed descriptions of the same points as those described above will be omitted. Further, the modification examples described below may be implemented individually or in combination as appropriate.

### (Modification)

In the above-described embodiments, the printer 1 includes the cutter 2. In a modification, a configuration having a peeling mechanism for peeling off a label in place of the cutter 2 will be described.

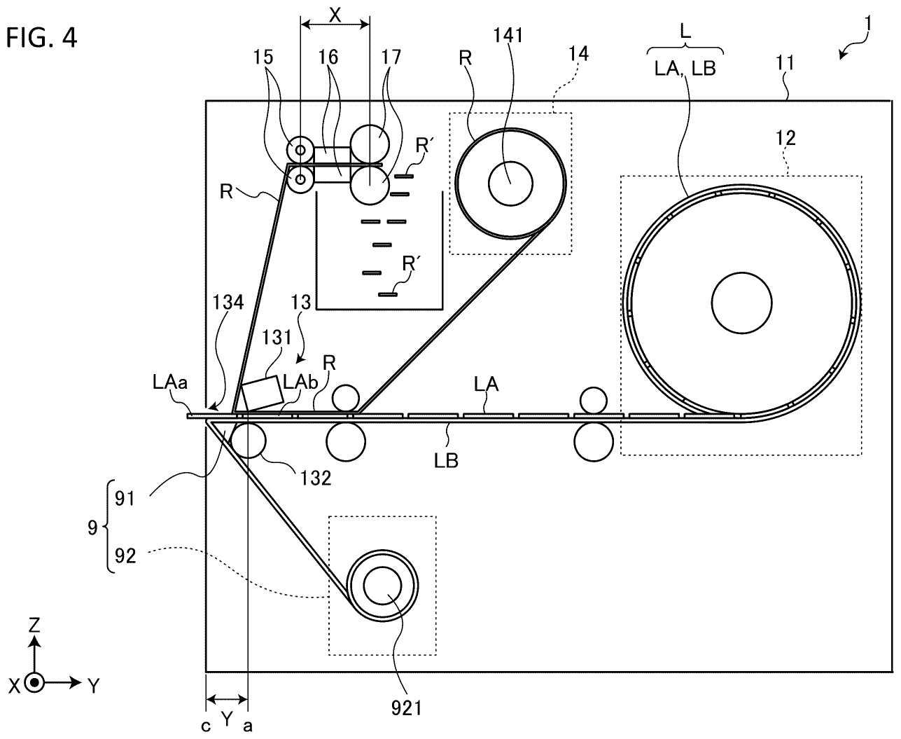

FIG. 4 is a schematic diagram illustrating an internal structure of a printer 1 according to a modification. As illustrated in FIG. 4, the printer 1 according to the modified example includes a housing 11, a medium holder 12, a printing unit 13, a peeling mechanism 9, an ink ribbon holder 14, a pair of ink ribbon conveying rollers 15, an ink ribbon conveying guide 16, a pair of shredding rollers 17, and a dust box 18.

The housing 11, the medium holder 12, the printing unit 13, the ink ribbon holder 14, the pair of ink ribbon conveying rollers 15, the ink ribbon conveying guide 16, the pair of shredding rollers 17, and the dust box 18 are the same as those in the above-described embodiments, and therefore, description thereof is omitted.

The peeling mechanism 9 peels off the label LA attached to the base sheet LB of the label sheet L. Specifically, the peeling mechanism 9 includes a peeling unit 91 and a base sheet holding unit 92.

The peeling unit 91 is disposed downstream of the platen 132 in the feeding direction of the label sheet L, and bends the base sheet LB at an acute angle in a direction away from the label LA in the course of conveying the label LA attached to the base sheet LB, thereby peeling off the label LA. The peeled label LA is discharged from the discharge port 134.

The base sheet holding unit 92 holds the base sheet LB from which the label LA has been peeled off by winding it in a roll shape. Specifically, the base sheet holding unit 92 includes a base sheet winding shaft 921.

The base sheet winding shaft 921 is rotated by a driving mechanism (not shown) via a gear train (not shown) arranged on a right side wall (not shown) of the printer 1, and winds up only the base sheet LB of the label sheet L that has passed through the peeling unit 91. The peeling part 91 and the base sheet winding shaft 921 are respectively positioned such that the base sheet winding shaft 921 winds the base sheet LB and bends the base sheet LB at an acute angle at the peeling unit 91.

Incidentally, in the case where the printer 1 includes the peeling mechanism 9 instead of the cutter 2, the back feed operation is generally performed in the same manner as in the case where the printer 1 includes the cutter 2. Hereinafter, a back feed operation of the printer 1 according to the modification will be described. In FIG. 4, the peeling position (i.e., the position of the discharge port 134) at which the label LA is peeled off from the base sheet LB by the peeling mechanism 9 is denoted by c, and the distance from the printing position a to the peeling position c (i.e., the conveyance distance of the label sheet L) is denoted by Y.

After printing on the label LA, the printer 1 moves the label sheet L so that the upper end portion of the label LAb is located at the peeling position c. Thus, the peeling mechanism 9 can peel the label LAa from the base sheet LB.

When the label LAa is peeled from the base sheet B, the upper end of the label LAb in the conveyance direction is located downstream of the position where the print head 131 and the platen 132 are located. Therefore, when the label LAa is peeled from the base sheet B, printing cannot be performed in an area located downstream of the positions of the print head 131 and the platen 132 on the label LAb.

Therefore, the printer 1 of the present modification performs an operation of pulling back the label sheet L by the distance Y so that the leading end portion of the label LAb is present at the printing position a after the label LAa is peeled off. This allows the printer 1 according to the present modification to print on the entire surface of the label LAb.

Also in the present modification, the pair of ink ribbon conveying rollers 15 and the pair of shredding rollers 17 are provided so that the relationship of X>=Y is satisfied as in the above-described embodiments. As a result, the printer 1 according to the present modification can achieve both cutting of the ink ribbon R and continuous peeling of the label sheet L by performing the back feed operation.

In the above description, a configuration has been described in which the peeling mechanism 9 is integrally provided with the printer 1, but the peeling mechanism 9 may be detachably attached to the printer 1. In the above description, the printer 1 includes the peeling mechanism 9 instead of the cutter 2, but the printer 1 may include the peeling mechanism 9 in addition to the cutter 2. In this case, the user may select whether to perform the cutting operation or the peeling operation.

According to the present modification, in addition to the effects achieved by the above-described embodiments, it is also possible to enable the back feed operation for the printer having the peeling mechanism for peeling the label.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A printer comprising:
a first holder for an ink ribbon;
a first pair of rollers configured to convey the ink ribbon along a conveyance path;
a print head configured to press the ink ribbon against a print medium to print an image on the print medium; and
a second pair of rollers disposed on a downstream side of the first pair of rollers in the conveyance path and capable of crosscutting the ink ribbon.

2. The printer according to claim 1, wherein
the second pair of rollers are shredding rollers by which the ink ribbon is cut along the conveyance path and a first direction crossing the conveyance path.

3. The printer according to claim 1, further comprising:
a receptacle disposed below the second pair of rollers and capable of storing the cut ink ribbon.

4. The printer according to claim 1, further comprising:
a second holder for holding the print medium;
a third pair of rollers configured to convey the print medium towards a discharge port; and
a blade disposed at the discharge port and by which a portion of the print medium is cut.

5. The printer according to claim 4, further comprising:
a platen that faces the print head, wherein
the ink ribbon and the print medium are sandwiched between the print head and the platen, and
a distance between the first pair of rollers and the second pair of rollers along the conveyance path is greater than or equal to a distance between the blade and the print head.

6. The printer according to claim 1, further comprising:
an ink ribbon guide extending between the first pair of rollers and the second pair of rollers along the conveyance path.

7. The printer according to claim 6, wherein
the ink ribbon guide includes a pair of plates extending parallel to each other such that the ink ribbon passes between the plates.

8. The printer according to claim 1, further comprising:
a discharge port from which the print medium is discharged;
a first blade fixed at the discharge port; and
a second blade disposed facing the first blade and movable to cut a portion of the print medium on which the image has been printed.

9. The printer according to claim 8, wherein
the print medium is a label sheet including a base sheet and a plurality of labels attached to the base sheet.

10. The printer according to claim 9, further comprising:
a peeling unit by which a label can be peeled off from the base sheet.

11. A method performed by a printer, the method comprising:
conveying, by a first pair of rollers, an ink ribbon held on a first holder along a conveyance path;
by a print head, pressing the ink ribbon against a print medium and printing an image on the print medium; and
after the printing, crosscutting the ink ribbon by a second pair of rollers disposed on a downstream side of the first pair of rollers in the conveyance path.

12. The method according to claim 11, wherein
the second pair of rollers are shredding rollers by which the ink ribbon is cut along the conveyance path and a first direction crossing the conveyance path.

13. The method according to claim 11, further comprising:
collecting the cut ink ribbon by a receptacle disposed below the second pair of rollers.

14. The method according to claim 11, further comprising:
conveying, by a third pair of rollers, the print medium towards a discharge port; and
cutting a portion of the print medium by a blade disposed at the discharge port.

15. The method according to claim 14, further comprising:
sandwiching the ink ribbon and the print medium between the print head and a platen, wherein
a distance between the first pair of rollers and the second pair of rollers along the conveyance path is greater than or equal to a distance between the blade and the print head.

16. The method according to claim 11, further comprising:
passing the ink ribbon along an ink ribbon guide extending between the first pair of rollers and the second pair of rollers along the conveyance path.

17. The method according to claim 16, wherein
the ink ribbon guide includes a pair of plates extending parallel to each other such that the ink ribbon passes between the plates.

18. The method according to claim 11, further comprising:
cutting a portion of the print medium on which the image has been formed by a first a first blade fixed at a discharge port and a second blade disposed facing the first blade and movable.

19. The method according to claim 18, wherein
the print medium is a label sheet including a base sheet and a plurality of labels attached to the base sheet.

20. The method according to claim 19, further comprising:
peeling off a label from the base sheet.
